(19) United States
(12) Patent Application Publication
(10) Pub. No.: US 2006/0078046 A1
(43) Pub. Date: Apr. 13, 2006

(54) Method and system for multi-path video delivery and distribution

(75) Inventor: Bin Lu, Santa Clara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aegison Corp., Santa Clara, CA (US)

(21) Appl. No.: 10/964,853

(22) Filed: Oct. 13, 2004

(51) Int. Cl. H04N 11/04; H04N 11/02; H04N 7/12; H04B 1/66

(52) U.S. Cl. 375/240.01

(57) ABSTRACT

A system and method for processing and transmitting signals. The system includes a first encoder configured to receive a digital video signal and encode the digital video signal based on a first encoding format, a second encoder configured to receive the digital video signal and encode the digital video signal based on a second encoding format, and a control system configured to receive a first encoded digital video signal and a second encoded digital video signal and output an third encoded digital video signal.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates in general to surveillance techniques. More particularly, the invention provides a system and method for multi-path video delivery and distribution. Merely by way of example, the invention is described as it applies to digital video recorders, but it should be recognized that the invention has a broader range of applicability.

Digital video cameras are commonly used for monitoring activities in various locations. These locations may include law enforcement, commercial, and private installments. For example, a digital video camera is pointed to an area of interest, and can capture and transmit images to a local or remote device. The local or remote device may be a display and/or a storage device. The display is often monitored by an operator, who can report unauthorized or suspicious activities to the appropriate party. The storage device usually records the images as data files. The data files may be uncompressed or compressed into various formats.

For example, the data files can be compressed into the MPEG format. The MPEG compression usually reduces redundancy between images. For example, certain individual images are treated as intra-frames for other images, and such other frames are referred to as inter-frames. The compression can reduce the redundancy of these inter-frames with respect to their corresponding intra-frame. As another example, the data files can be compressed into the JPEG format. The JPEG compression divides up an image into pixel blocks, and then calculates and rounds off the discrete cosine transform of each block. Such rounding-off can produce the lossy nature of JPEG but allow for significant compression ratio.

Even though compression techniques can reduce sizes of image files, the file sizes may still exceed the transmission capability between the digital video camera and the local or remote device.

Hence it is highly desirable to improve techniques for video delivery and distribution.

### BRIEF SUMMARY OF THE INVENTION

The present invention relates in general to surveillance techniques. More particularly, the invention provides a system and method for multi-path video delivery and distribution. Merely by way of example, the invention is described as it applies to digital video recorders, but it should be recognized that the invention has a broader range of applicability.

According to one embodiment of the present invention, a system for processing and transmitting signals includes a first encoder configured to receive a digital video signal and encode the digital video signal based on a first encoding format, a second encoder configured to receive the digital video signal and encode the digital video signal based on a second encoding format, and a control system configured to receive a first encoded digital video signal and a second encoded digital video signal and output a third encoded digital video signal. The first encoded digital video signal is associated with the digital video signal encoded based on the first encoding format and is related to a first frame rate and a first image resolution, the second encoded digital video signal is associated with the digital video signal encoded based on the second encoding format and is related to a second frame rate and a second image resolution, and the third encoded digital video signal is associated with a third encoding format, a third frame rate, and a third image resolution. The control system is further configured to receive a control signal, process information associated with the control signal, and generate the third encoded digital video signal based on at least information associated with the first encoded digital video signal, the second encoded digital video signal and the control signal.

According to another embodiment of the present invention, a system for processing and transmitting signals includes a first encoder configured to receive a digital video signal and encode the digital video signal based on a first encoding format, a second encoder configured to receive the digital video signal and encode the digital video signal based on a second encoding format, and a control system configured to receive a control signal, a first encoded digital video signal and a second encoded digital video signal and output a third encoded digital video signal in response to the control signal. The first encoded digital video signal is associated with the digital video signal encoded based on the first encoding format, and the second encoded digital video signal is associated with the digital video signal encoded based on the second encoding format. The control system includes a buffer handler configured to receive the first encoded digital video signal and the second encoded digital video signal, a filter coupled to the buffer, and an interface system coupled to the filter. The buffer handler is further configured to output a fourth encoded digital video signal based on at least information associated with the control signal, the fourth encoded digital video signal being the same as the first encoded digital video signal or the second encoded digital video signal, the fourth encoded digital video signal being associated with the fourth frame rate and the fourth image resolution. The filter is configured to adjust at least one of the fourth frame rate and the fourth image resolution based on at least information associated with the control signal. The interface system is configured to generate the third encoded digital video signal based on at least information associated with the fourth encoded digital video signal.

According to yet another embodiment of the present invention, a method for processing and transmitting signals includes receiving a digital video signal, encoding the digital video signal based on a first encoding format, encoding the digital video signal based on a second encoding format, receiving a first encoded digital video signal and a second encoded digital video signal, and generating a third encoded digital video signal. The first encoded digital video signal is associated with the digital video signal encoded based on the first encoding format and is related to a first frame rate and a first image resolution, the second encoded digital video signal is associated with the digital video signal encoded based on the second encoding format and is related to a second frame rate and a second image resolution, and the third encoded digital video signal is associated with a third encoding format, a third frame rate, and a third image resolution. The generating a third encoded digital video signal includes receiving a control signal, processing information associated with the control signal, and generating the third encoded digital video signal based on at least information associated with the first encoded digital video signal, the second encoded digital video signal and the control signal.

Many benefits are achieved by way of the present invention over conventional techniques. Some embodiments of the present invention provide multiple paths for video and/or audio delivery and distribution. These paths utilize different compression techniques. Certain embodiments of the present invention implement at least two different video encoding techniques, one of which serves wide bandwidth transfer and the other of which serves low bandwidth transfer. For example, the wide bandwidth transfer is carried out over a WiFi network and/or a 3G wireless network and uses the JPEG 2000 compression standard at appropriate resolution. As another example, the narrow bandwidth transfer is carried out over a GPRS network and/or a CDMA network and uses the MPEG-2 compression standard at appropriate frame rate. In yet another example, the MPEG-2 encoding technique is used for local storage or display device. Some embodiments of the present invention select digital data encoded under a desirable compression standard from multiple encoding standards and output the digital data to the intended recipient in response to certain control parameters. For example, the control parameters are specified in a control signal or determined based on information provided by the control signal.

Various additional objects, features and advantages of the present invention can be more fully appreciated with reference to the detailed description and accompanying drawings that follow.

### BRIEF DESCRIPTION OF THE DRAWINGS

FIG. 1 is a simplified system for multi-path video delivery and distribution according to an embodiment of the present invention;

FIG. 2 is a simplified control system according to an embodiment of the present invention.

### DETAILED DESCRIPTION OF THE INVENTION

The present invention relates in general to surveillance techniques. More particularly, the invention provides a system and method for multi-path video delivery and distribution. Merely by way of example, the invention is described as it applies to digital video recorders, but it should be recognized that the invention has a broader range of applicability.

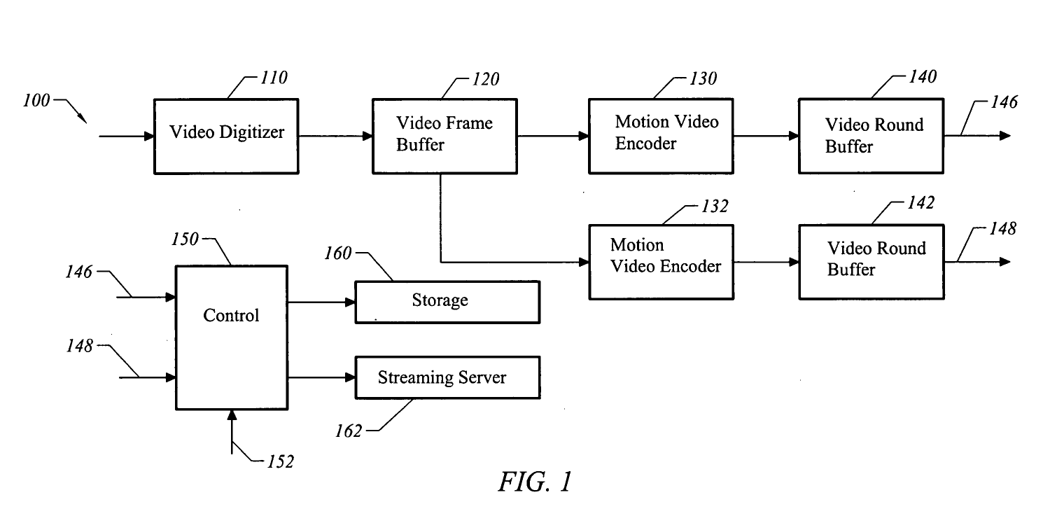

FIG. 1 is a simplified system for multi-path video delivery and distribution according to an embodiment of the present invention. This diagram is merely an example, which should not unduly limit the scope of the claims. One of ordinary skill in the art would recognize many variations, alternatives, and modifications. A system 100 includes the following components:
1. video digitizer 110,
2. video frame buffer 120,
3. motion video encoders 130 and 132,
4. video round buffers 140 and 142,
5. control system 150,
6. storage device 160, and
7. streaming server 170.

Although the above has been shown using a selected group of apparatuses for the system 100, there can be many alternatives, modifications, and variations. For example, some of the apparatuses may be expanded and/or combined. Other apparatuses may be inserted to those noted above. As an example, one or more additional motion video encoders can be connected to the video frame buffer 120. Each additional motion video encoder is linked to an additional video round buffer, which is connected to the control system 150. As another example, video signals received, processed and/or transmitted by the system 100 include audio signals. In yet another example, video signals received, processed and/or transmitted by the system 100 do not include any audio signals. Depending upon the embodiment, the arrangement of apparatuses may be interchanged with others replaced. Further details of these apparatuses are found throughout the present specification and more particularly below.

The video digitizer 110 converts an analog video signal to a digital video signal. In one embodiment, the video digitizer 110 includes a chipset converting an analog video and audio input to digital video and audio data. In another embodiment, the video digitizer 110 receives an analog video signal from an imaging device. For example, the imaging device includes a CCD array or a CMOS array. In another example, the imaging device is sensitive to visible wavelengths or wavelengths in another range. Such another range covers the infrared band or the ultra-violet band. In yet another example, the imaging device is a camera. In another embodiment, the analog video signal received by the video digitizer includes an analog audio signal. For example, the analog audio signal is captured by a microphone device. The microphone device may be part of an analog video apparatus with imaging capability.

The video frame buffer 120 receives and stores the digital signal from the video digitizer 110. In one embodiment, the video frame buffer includes a memory of a predetermined size. When a digital signal is recorded, the signal may replace a signal previously stored if the unused memory is not sufficiently large. In another embodiment, the digital signal is organized a frame-by-frame basis, and is also stored in the video frame buffer 120 on the frame-by-frame basis. For example, the video frame buffer 120 receives and records 30 frames per second. The frame rate may change with various embodiments of the present invention.

The motion video encoder 130 and 132 each receive and compress a digital signal from the video frame buffer 120. In one embodiment, the video encoder 130 and 132 each use hardware and/or software to compress raw video data. As an example, the digital signal being compressed includes both video and audio data. In another embodiment, the motion video encoders 130 and 132 receive the same digital signal but use different types of compression techniques. For example, the compression technique is selected from the MPEG series, H.26x series, and JPEG series. As another example, the encoder 130 supports the MPEG compression format, and the encoder 132 supports the JPEG compression format.

The MPEG compression usually reduces redundancy between images. Certain individual images are treated as intra-frames for other images, and such other frames are referred to as inter-frames. The compression can reduce the redundancy of these inter-frames with respect to their corresponding intra-frame. As another example, the digital signal can be compressed into the JPEG format. The JPEG compression divides up an image into pixel blocks, and then calculates and rounds off the discrete cosine transform of each block. Such rounding-off can produce the lossy nature of JPEG but allow for significant compression ratio.

The video round buffer 140 is connected to the motion video encoder 130, and the video round buffer 142 is connected to the motion video encoder 132. In one embodiment, each of the vide round buffer 140 and 142 includes a memory associated with an input terminal and an output terminal. The input terminal receives digital data that are to be recorded into the memory, and the output terminal sends digital data that has been read from the memory. In one example, the memory uses a head pointer and a tail pointer. The head pointer indicates the reading position of the memory, and the tail pointer indicates the writing position of the memory. As an example, the tail pointer should not catch the head pointer; otherwise an underflow occurs. The head pointer should not catch the tail pointer; otherwise an overflow occurs. In another embodiment, the video round buffers 140 and 142 each is capable to store digital data for a plurality of frames. If the bit rate for input digital data is smaller than the bit rate for output digital data, the video round buffer can read from its memory and support the output bit rate for a period of time. If the input bit rate is higher than the output bit rate, the video round buffer can store the received signal into its memory for a period of time without losing received information or overwriting information that was previously stored and remains useful.

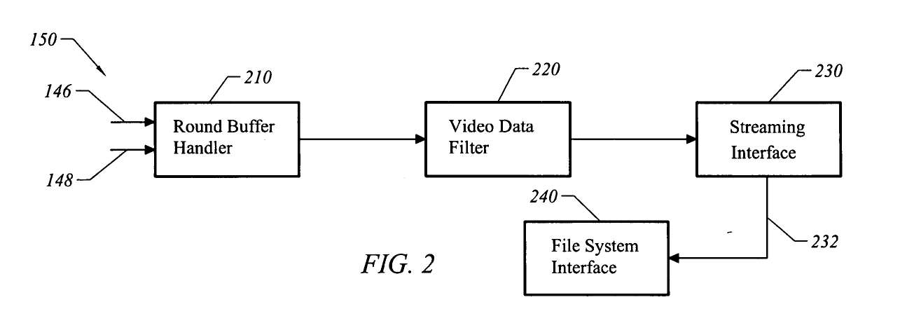

The control system 150 receives digital signals 146 and 148 from the video round buffers 140 and 142 respectively, and deliver a video and/or audio signal in response to a control signal 152. FIG. 2 is a simplified control system 150 according to an embodiment of the present invention. This diagram is merely an example, which should not unduly limit the scope of the claims. One of ordinary skill in the art would recognize many variations, alternatives, and modifications. The system 150 includes the following components:
1. round buffer handler 210,
2. video data filter 220,
3. streaming interface 230, and
4. file system interface 240.

Although the above has been shown using a selected group of apparatuses for the system 150, there can be many alternatives, modifications, and variations. For example, some of the apparatuses may be expanded and/or combined. Other apparatuses may be inserted to those noted above. The round buffer handler 210 may receive the digital signal 146 from the video round buffer 140, and another round buffer handler is inserted to receive the digital signal 148 from the video round buffer 150. Depending upon the embodiment, the arrangement of apparatuses may be interchanged with others replaced. Further details of these apparatuses are found throughout the present specification and more particularly below.

Some or all of the apparatuses 210, 220, 230 and 240 receive the control signal 152. In one embodiment, the control signal 152 is sent from a remote or local device. For example, the remote or local device receives the video and/or audio data from the control system 152 in response to the control signal 152. In another example, the remote or local device includes a sensor that can be triggered by the occurrence of a certain event. In yet another example, the remote or local device includes a switch that is controlled manually or automatically. In yet another example, the remote or local device includes a storage unit and/or a display apparatus. In yet another example, the remote or local device communicates with the control system 150 through a wired connection and/or a wireless connection. In another embodiment, the control signal 152 is obtained from a memory unit, which is also a component of the system 100. The memory unit stores various predetermined specifications. As an example, these predetermined specifications can be adjusted manually or automatically by a local or remote device. In yet another embodiment, specifications conveyed through the control signal 152 are provided by a user through a specific user interface (UI). For example, the user inputs such specifications through a local keyboard and/or display, or through a remote personal computer by accessing a remote configurable interface such as web (HTML) interface.

The control signal 152 contains various types of information. In one embodiment, the control signal 152 specifies some or all of an encoding format, a frame rate, an image resolution, and a transmission rate for video and/or audio signal. As an example, the control signal 152 provides a desirable encoding format, a desirable frame rate, and a desirable image resolution. In another example, the control signal 152 specifies MPEG-2 as desirable compression format and a frame rate. In yet another example, the control signal 152 specifies JPEG 2000 as desirable compression format and an image resolution. In another embodiment, the control signal 152 specifies a transmission bit rate for video and/or audio signal and an image resolution. In response, a processing unit of the control system can determine and send an appropriate encoding format and an appropriate frame rate to some or all of some or all of the apparatuses 210, 220, 230 and 240. For example, the MPEG format is selected for a frame rate higher than 2 frames per second and lower than 31 frames per second. In another example, the JPEG format is selected for a frame rate lower than 3 frames per second.

The round buffer handler 210 receives the digital signals 146 and 148 from the video round buffers 140 and 150 respectively and controls the data recycling in these two video round buffers. In one embodiment, the round buffer handler 210 adjusts its reading speed from each of the video round buffers 140 and 150, so that the reading speed is substantially the same as the writing speed for the same round buffer. For example, if the round buffer handler 210 detects an overflow in the round buffer 140 or 150, the round buffer handler 210 increases its reading bit rate from the same round buffer. If the round buffer handler 210 detects an underflow in the round buffer 140 or 150, the round buffer handler 210 reduces its reading bit rate from the same round buffer.

As discussed above, the round buffer handler 210 receives the digital signals 146 and 148, which may have been encoded under different compression standards. In one embodiment, the desirable encoding format is transmitted to the round buffer handler 210, and the round buffer handler 210 in response outputs the digital signal encoded under only the desirable compression standard. For example, the desirable compression standard is MPEG-2 or JPEG 2000.

The video data filter 220 receives the digital data from the round buffer handler 210 and processes these video and/or audio data in response to information obtained and/or determined from the control signal 152. In one embodiment, the received digital data is encoded under MPEG-2, and is processed by the video filter 220 according to the desirable frame rate. For example, the desirable frame rate is lower than the frame rate of the received digital data. Some of the received digital data for certain frames is discarded. In another example, the received digital data for multiple frames are used to generate digital data for a composite frame when the desirable frame rate is lower than the received frame rate. In yet another example, the frame rate of the received digital data is 30 frames per second.

In another embodiment, the received digital data is encoded under JPEG 2000, and is processed by the video filter 220 according to the desirable image resolution. For example, the desirable resolution is lower than the resolution of the received digital data. Some of the received digital data for certain pixels are discarded. In another example, the received digital data for multiple pixels are used to generate digital data for a composite pixel when the desirable image resolution is lower than the received image resolution. In yet another embodiment, the video data filter 220 not only receives and processes the digital data from the round buffer handler 210 but also determines related data. For example, the related data include digital watermark, time stamp, and/or DVR identification.

The video data filter 220 outputs the processed digital data and the determined related data to the steaming interface 230. In one embodiment, the streaming interface 230 inserts some or all of the related data into the processed video frames. In another embodiment, the streaming interface 230 provides synchronization between image information and audio information. In yet another embodiment, the streaming interface 240 generates packets based on the processed digital data and the determined related data. Additionally, the streaming interface 240 generates headers for the data packets.

The file system interface 240 receives data 232 from the streaming interface 230. For example, the data 232 include data packets with appropriate headers. In one embodiment, a plurality of data packets are organized into a file block. As an example, the control signal 152 that is received by the file system interface 240 specifies the recipient as a local storage device. Accordingly the file block is generated for storage purpose and transmitted to the storage device 160. In another example, the control signal 152 specifies the recipient to be a local display device. The local storage or display device may be directly linked to the control system 150, and could be a short or long distance away from the control system. In yet another example, the control signal 152 specifies the recipient to be a remote device. Accordingly, the file block is generated for transport purpose through the streaming server 162. The remote device may be a storage device, a display device, or other apparatus, and linked to the control system 150 through a network. Additionally, the remote device may be a short or long distance away from the control system. In yet another example, the control signal 152 specifies the recipient to be a local storage device, a local display device, and/or a remote device. Accordingly, one or more file blocks are generated and sent to the recipient directly or through the streaming server 162 or other intermediate apparatus.

Returning to FIG. 1, in one embodiment, the storage device 160 includes a file system and a memory unit. As an example, the memory unit includes a hard disk and/or a flash memory. In another example, the memory unit includes a read-only memory and/or a random-access memory. In yet another example, the file system is a real linear file system. The file system communicates with the memory unit through storage media driver. In another embodiment, the storage device 160 includes a memory unit, and a file system resides within the memory unit as a file.

In one embodiment, the streaming server 162 serves the request for video and/or audio transferring. Upon receipt of the request, the streaming server 162 analyzes the request and sends a control signal to the control system 150. For example, the control signal is the control signal 152. In response, the streaming server 162 receives the digital data from the file system interface 240 of the control system 150 and sends the compressed digital video and/or audio data to the intended recipient. In another embodiment, the streaming server 162 receives the digital data and certain instructions from the file system interface 240 of the control system 150 and sends the compressed digital video and/or audio data to the intended recipient in response to such instructions.

In yet another embodiment, the streaming server 162 supports one or more formats of UDP, HTTP, and RTSP. The transmission from the streaming server and the intended recipient can be carried out over a wired network and/or a wireless network. For example, the wired network is linked with regular phone lines and/or physical cables such as CAT5 Ethernet cables. The network can support a dial-up connection and/or a high-speed Ethernet connection. In another example, the wireless network includes a WiFi network, a GPRS network, a CDMA network, and/or a 3G wireless network. In yet another embodiment, the streaming server supports a virtual file system that can communicates with one or more drivers for different networks and/or connections. Such drivers may includes an Ethernet driver and/or a GPRS modem driver.

According to another embodiment of the present invention, a method implemented by the system 100 for processing and transmitting signals includes receiving a digital video signal, encoding the digital video signal based on a first encoding format, encoding the digital video signal based on a second encoding format, receiving a first encoded digital video signal and a second encoded digital video signal, and generating a third encoded digital video signal. The first encoded digital video signal is associated with the digital video signal encoded based on the first encoding format and is related to a first frame rate and a first image resolution, the second encoded digital video signal is associated with the digital video signal encoded based on the second encoding format and is related to a second frame rate and a second image resolution, and the third encoded digital video signal is associated with a third encoding format, a third frame rate, and a third image resolution. The generating a third encoded digital video signal includes receiving a control signal, processing information associated with the control signal, and generating the third encoded digital video signal based on at least information associated with the first encoded digital video signal, the second encoded digital video signal and the control signal.

The present invention has various applications. For example, the system 100 can be implemented on a mobile unit for digital surveillance. The mobile unit may be a helicopter, an automobile, a motorcycle, or other moving vehicle such as one used in a roller coast ride. In another example, the system 100 may be implemented on a fixed unit, such as one uses for a commercial mall or a private home.

The present invention has various advantages over conventional techniques. Some embodiments of the present invention provide multiple paths for video and/or audio delivery and distribution. These paths utilize different compression techniques. Certain embodiments of the present invention implement at least two different video encoding techniques, one of which serves wide bandwidth transfer and the other of which serves low bandwidth transfer. For example, the wide bandwidth transfer is carried out over a WiFi network and/or a 3G wireless network and uses the JPEG 2000 compression standard at appropriate resolution. As another example, the narrow bandwidth transfer is carried out over a GPRS network and/or a CDMA network and uses the MPEG-2 compression standard at appropriate frame rate. In yet another example, the MPEG-2 encoding technique is used for local storage or display device. Some embodiments of the present invention select digital data encoded under a desirable compression standard from multiple encoding standards and output the digital data to the intended recipient in response to certain control parameters. For example, the control parameters are specified in a control signal or determined based on information provided by the control signal.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for processing and transmitting signals, the system comprising:
a first encoder configured to receive a digital video signal and encode the digital video signal based on a first encoding format;
a second encoder configured to receive the digital video signal and encode the digital video signal based on a second encoding format;
a control system configured to receive a first encoded digital video signal and a second encoded digital video signal and output a third encoded digital video signal;
wherein:
the first encoded digital video signal is associated with the digital video signal encoded based on the first encoding format and is related to a first frame rate and a first image resolution;
the second encoded digital video signal is associated with the digital video signal encoded based on the second encoding format and is related to a second frame rate and a second image resolution;
the third encoded digital video signal is associated with a third encoding format, a third frame rate, and a third image resolution.
wherein the control system is further configured to
receive a control signal;
process information associated with the control signal;
generate the third encoded digital video signal based on at least information associated with the first encoded digital video signal, the second encoded digital video signal and the control signal.

2. The system of claim 1 wherein the third format is the same as the first format, and the third image resolution is different from the first image resolution.

3. The system of claim 2 wherein the first format is a JPEG format.

4. The system of claim 1 wherein the third format is the same as the first format, and the third frame rate is different from the first frame rate.

5. The system of claim 4 wherein the first format is a MPEG format.

6. The system of claim 1 wherein the generate the third encoded digital video signal comprises:
generate a fourth encoded digital video signal based on at least information associated with the control signal, the fourth encoded digital video signal being the same as the first encoded digital video signal or the second encoded digital video signal, the fourth encoded digital video signal being associated with the fourth frame rate and the fourth image resolution;
adjust at least one of the fourth frame rate and the fourth image resolution based on at least information associated with the control signal;
generate the third encoded digital video signal based on at least information associated with the fourth encoded digital video signal.

7. The system of claim 6, and further comprising a streaming server connected to a network and configured to receive the fourth encoded digital signal in response to at least the control signal.

8. The system of claim 7 wherein the network includes a wireless network.

9. The system of claim 8 wherein the wireless network includes at least one selected from a group consisting of a WiFi network, a GPRS network, a CDMA network, and a 3G wireless network.

10. The system of claim 7 wherein the network includes a wired network.

11. The system of claim 10 wherein the wired network is capable of supporting at least one selected from a group consisting of a dial-up connection and an Ethernet connection.

12. The system of claim 6, and further comprising a receiving device directly connected to the control system and configured to receive the fourth encoded digital signal in response to at least the control signal.

13. The system of claim 12 wherein the receiving device includes at least one selected from a group consisting of a storage device and a display device.

14. The system of claim 1, and further comprising a digitizer configured to receive an analog video signal and generate the digital video signal based on at least information associated with the analog video signal.

15. The system of claim 1 wherein the digital video signal comprises video and audio information.

16. The system of claim 1 wherein each of the first encoded digital video signal, the second encoded digital video signal, and the third encoded digital video signal comprises video and audio information.

17. The system of claim 1, and further comprising:
a first buffer coupled to the first encoder and the control system;
a second buffer coupled to the first encoder and the control system.

18. The system of claim 16 wherein the control system comprises:
a buffer handler configured to receive the first encoded digital video signal from the first buffer and the second encoded digital video signal from the second buffer;
a filter coupled to the buffer.
wherein the buffer handler is further configured to output a fourth encoded digital video signal based on at least information associated with the control signal, the fourth encoded digital video signal being the same as the first encoded digital video signal or the second encoded digital video signal, the fourth encoded digital video signal being associated with the fourth frame rate and the fourth image resolution;
wherein the filter is configured to adjust at least one of the fourth frame rate and the fourth image resolution based on at least information associated with the control signal.

19. The system of claim 18, and further comprising an interface system configured to generate the third encoded digital video signal based on at least information associated with the fourth encoded digital video signal.

20. The system of claim 19 wherein the interface system comprises a streaming interface and a file system interface.

21. A system for processing and transmitting signals, the system comprising:
a first encoder configured to receive a digital video signal and encode the digital video signal based on a first encoding format;
a second encoder configured to receive the digital video signal and encode the digital video signal based on a second encoding format;
a control system configured to receive a control signal, a first encoded digital video signal and a second encoded digital video signal and output a third encoded digital video signal in response to the control signal;
wherein:
the first encoded digital video signal is associated with the digital video signal encoded based on the first encoding format;
the second encoded digital video signal is associated with the digital video signal encoded based on the second encoding format;
wherein the control system includes:
a buffer handler configured to receive the first encoded digital video signal and the second encoded digital video signal;
a filter coupled to the buffer;
an interface system coupled to the filter;
wherein:
the buffer handler is further configured to output a fourth encoded digital video signal based on at least information associated with the control signal, the fourth encoded digital video signal being the same as the first encoded digital video signal or the second encoded digital video signal, the fourth encoded digital video signal being associated with the fourth frame rate and the fourth image resolution;
the filter is configured to adjust at least one of the fourth frame rate and the fourth image resolution based on at least information associated with the control signal;
the interface system is configured to generate the third encoded digital video signal based on at least information associated with the fourth encoded digital video signal.

22. A method for processing and transmitting signals, the method comprising:
receiving a digital video signal;
encoding the digital video signal based on a first encoding format;
encoding the digital video signal based on a second encoding format;
receiving a first encoded digital video signal and a second encoded digital video signal;
generating a third encoded digital video signal;
wherein:
the first encoded digital video signal is associated with the digital video signal encoded based on the first encoding format and is related to a first frame rate and a first image resolution;
the second encoded digital video signal is associated with the digital video signal encoded based on the second encoding format and is related to a second frame rate and a second image resolution;
the third encoded digital video signal is associated with a third encoding format, a third frame rate, and a third image resolution.
wherein the generating a third encoded digital video signal includes:
receiving a control signal;
processing information associated with the control signal;
generating the third encoded digital video signal based on at least information associated with the first encoded digital video signal, the second encoded digital video signal and the control signal.

23. The method of claim 22 wherein the third format is the same as the first format, and the third image resolution is different from the first image resolution.

24. The method of claim 22 wherein the third format is the same as the first format, and the third frame rate is different from the first frame rate.

25. The method of claim 22 wherein the generating the third encoded digital video signal based on at least information associated with the first encoded digital video signal, the second encoded digital video signal and the control signal comprises:
generating a fourth encoded digital video signal based on at least information associated with the control signal, the fourth encoded digital video signal being the same as the first encoded digital video signal or the second encoded digital video signal, the fourth encoded digital video signal being associated with the fourth frame rate and the fourth image resolution;
adjusting at least one of the fourth frame rate and the fourth image resolution based on at least information associated with the control signal;
generating the third encoded digital video signal based on at least information associated with the fourth encoded digital video signal.

26. The method of claim 25, and further comprising:
receiving the fourth encoded digital signal in response to at least the control signal by a streaming server;
wherein the streaming server is connected to a network.

27. The method of claim 26 wherein the network includes a wireless network.

28. The method of claim 26 wherein the network includes a wired network.

29. The method of claim 25, and further comprising:
receiving the fourth encoded digital signal in response to at least the control signal by a receiving device.

30. The method of claim 29 wherein the receiving device includes at least one selected from a group consisting of a storage device and a display device.

31. The method of claim 22 wherein the digital video signal comprises video and audio information.

32. The method of claim 22 wherein each of the first encoded digital video signal, the second encoded digital video signal, and the third encoded digital video signal comprises video and audio information.
